(19) United States
(12) Patent Application Publication
(10) Pub. No.: US 2026/0061794 A1
(43) Pub. Date: Mar. 5, 2026

(54) UPPER SUPPORT

(71) Applicant: SUMITOMO RIKO COMPANY LIMITED, Komaki-Shi (JP)

(72) Inventors: Nachia ISOBE, Komaki-Shi (JP); Kazuki HOTTA, Komaki-Shi (JP)

(73) Assignee: SUMITOMO RIKO COMPANY LIMITED, Komaki-Shi (JP)

(21) Appl. No.: 19/266,241

(22) Filed: Jul. 11, 2025

(30) Foreign Application Priority Data
Aug. 27, 2024 (JP) 2024-145942

(51) Int. Cl. B60G 13/00

(52) U.S. Cl. CPC B60G 13/003; B60G 2204/41

(57) ABSTRACT

An upper support including an inner attachment member and an outer attachment member connected by an elastic connection body, the outer attachment member including upper and lower metal members overlapped on each other, the inner attachment member and the elastic connection body being arranged between the upper and lower metal members. The upper metal member and the lower metal member are penetrated by an upper attachment hole and a lower attachment hole respectively in a vertical direction. A clinching nut comprising a head part overlapped on a lower surface of the lower metal member is inserted through the lower attachment hole from below and is fitted and fixed to the upper attachment hole such that the upper and lower metal members are fixed to each other in an overlapped state by means of the clinching nut alone.

### INCORPORATED BY REFERENCE

The disclosure of Japanese Patent Application No. 2024-145942 filed on Aug. 27, 2024 including the specification, drawings and abstract is incorporated herein by reference in its entirety.

### BACKGROUND ART

### 1. Technical Field The present disclosure relates to an upper support for connecting a piston rod of a shock absorber in a vehicle suspension to a vehicle body in a vibration damping manner.

### 2. Description of the Related Art

An upper support is conventionally known which is interposed between a piston rod of a shock absorber in a vehicle suspension and a vehicle body, and connects the upper part of the piston rod to the vehicle body in a vibration damping manner. As disclosed in Japanese Unexamined Patent Publication No. JP-A-2010-014133, for example, the upper support has a structure in which an inner attachment member attached to the piston rod and an outer attachment member attached to the vehicle body are elastically connected to each other by an elastic connection body.

### SUMMARY

Meanwhile, as shown in JP-A-2010-014133, the upper support may adopt a structure in which the outer attachment member is composed of an upper metal member and a lower metal member, which are vertically overlapped on each other, and the inner attachment member and the elastic connection body are arranged between the upper metal member and the lower metal member. In such a structure, the upper metal member and the lower metal member are fixed in a mutually overlapped state, so as to prevent the inner attachment member and the elastic connection body from falling out of the outer attachment member. In JP-A-2010-014133, as shown in FIG. 8 thereof, tightening bolts for tightening the outer attachment member to the vehicle body fix the upper metal member and the lower metal member to each other by being press-fitted from below into bolt holes perforating the upper metal member and the lower metal member, and by being swaged at a serration part.

In the fixing structure of the upper metal member and the lower metal member using the tightening bolts as described in JP-A-2010-014133, the tightening bolts protrude significantly upward from the outer attachment member, which requires wide space on the upper side of the upper support to allow the protrusion of the tightening bolts. However, depending on the layout of the components on the vehicle side, it is often difficult to ensure sufficient space on the upper side of the upper support.

It is therefore one object of the present disclosure to provide an upper support of novel structure which can be adopted even when the space on the upper side is narrow.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides an upper support comprising: an inner attachment member configured to be attached to a piston rod of a shock absorber in a suspension of a vehicle; an outer attachment member configured to be attached to a vehicle body; and an elastic connection body connecting the inner attachment member and the outer attachment member, wherein the outer attachment member comprises an upper metal member and a lower metal member overlapped on each other, and the inner attachment member and the elastic connection body are arranged between the upper metal member and the lower metal member, the upper metal member includes at least one upper attachment hole penetrating the upper metal member in a vertical direction, and the lower metal member includes at least one lower attachment hole penetrating the lower metal member in the vertical direction, and at least one clinching nut comprising a head part overlapped on a lower surface of the lower metal member is inserted through the lower attachment hole from below and is fitted and fixed to the upper attachment hole such that the upper metal member and the lower metal member are fixed to each other in an overlapped state by means of the clinching nut alone.

According to the upper support structured following the present preferred embodiment, the tightening structure with respect to the vehicle side comprises the clinching nut. Thus, in comparison with the case where the tightening structure comprises an anchor bolt protruding upward, for example, the amount of protrusion above the upper metal member is reduced, thereby decreasing space required above the upper support.

Besides, the upper metal member and the lower metal member are connected only by means of a structure in which the clinching nut is fitted and fixed to the upper attachment hole without needing welding or swaging between the two metal members or the like. This makes it possible to provide the outer attachment member with the tightening structure with respect to the vehicle body side while fixing the upper and lower metal members constituting the outer attachment member to each other, thereby reducing the number of manufacturing processes.

A second preferred embodiment provides the upper support according to the first preferred embodiment, wherein both the upper metal member and the lower metal member comprise pre-painted metal members that have been painted in advance.

Conventionally, welding has sometimes been adopted as a means of fixing the upper metal member and the lower metal member. In the structure in which a nut for tightening with respect to the vehicle body is adopted, the said nut may also be attached by welding. In the case where welding is used in this way, when the upper metal member and the lower metal member comprise pre-painted metal members, problems such as the paint melting due to the heat of welding may occur, making it difficult to adopt the pre-painted metal members. It is also conceivable to perform spray painting after welding, but in spray painting after welding, it is difficult to paint the surfaces on the overlapped side of the upper metal member and the lower metal member (the inner surfaces of the area where the inner attachment member and the elastic connection body are housed). In such a case, there is a risk that rainwater or the like could penetrate between the upper metal member and the lower metal member, causing rust formation.

Here, in the structure of the present disclosure, the upper metal member and the lower metal member are fixed to each other by the clinching nut alone. Thus, even if the pre-painted metal members are adopted for the upper metal member and the lower metal member, problems such as those caused in the case of fixing by welding will not occur. Therefore, by adopting the structure according to the present preferred embodiment in which the upper metal member and the lower metal member comprise the pre-painted metal members, it is possible to achieve excellent rust-proofing performance due to the entire metal members having been painted in advance.

A third preferred embodiment provides the upper support according to the first or second preferred embodiment, wherein the clinching nut further comprises an insertion part inserted into the lower attachment hole and a fitting part fitted into the upper attachment hole, and an outer circumferential surface of the insertion part comprises a cylindrical surface, and an outer circumferential surface of the fitting part comprises a knurling part.

According to the upper support structured following the present preferred embodiment, the outer circumferential surface of the insertion part, which is inserted without being fitted into the lower attachment hole, comprises a smooth cylindrical surface. This eliminates unnecessary processes and also simplifies the mold for molding the clinching nut. Besides, the outer circumferential surface of the fitting part, which is fitted into the upper attachment hole, comprises the knurled part comprising a multitude of concave and convex portions. With this configuration, there is an expectation for preventing rotation of the clinching nut in the fitted state in the upper attachment hole, and improving fixing force by means of fitting.

A fourth preferred embodiment provides the upper support according to the third preferred embodiment, wherein an upper end of the clinching nut comprises an expansion part protruding upward from the fitting part and expanding toward a protruding distal end side.

According to the upper support structured following the present preferred embodiment, when a bolt is screwed onto the clinching nut from the upper side, the bolt is guided to the appropriate position with respect to the clinching nut by the expansion part, thereby facilitating tightening of the bolt with respect to the clinching nut. It can also be expected, for example, that the expansion part will exhibit a detent function as a return due to deformation of the upper metal member by the fitting part being fitted therein.

A fifth preferred embodiment provides the upper support according to the third or fourth preferred embodiment, wherein the fitting part has a maximum outside diameter dimension that is smaller than that of the insertion part.

According to the upper support structured following the present preferred embodiment, a stepped part is formed between the insertion part and the fitting part due to the difference in outside diameters between the insertion part and the fitting part. This makes it possible to appropriately set the amount of insertion of the clinching nut into the upper and lower attachment holes.

A sixth preferred embodiment provides the upper support according to any one of the third through fifth preferred embodiments, wherein the fitting part has a vertical length dimension that is within a range of 30%-80% of a hole length dimension of the upper attachment hole.

According to the upper support structured following the present preferred embodiment, the fitted area of the fitting part with respect to the hole inner surface of the upper attachment hole is sufficiently obtained. Besides, for example, even if fitting of the fitting part causes deformation of the wall of the upper attachment hole in the upper metal member such as upward thickness deviation or the like, it is possible to inhibit the said deformed portion from protruding above the upper metal member.

A seventh preferred embodiment provides the upper support according to any one of the first through sixth preferred embodiments, wherein the clinching nut includes an attachment shaft part protruding from the head part and inserted through the lower attachment hole while being fitted into the upper attachment hole, and the attachment shaft part has a length dimension that is not greater than a sum of hole length dimensions of the upper attachment hole and the lower attachment hole.

According to the upper support structured following the present preferred embodiment, the attachment shaft part of the clinching nut can be prevented from protruding above the upper metal member. Therefore, for example, in the case where a member on the vehicle body side is overlapped on the upper surface of the upper metal member, the attachment shaft part of the clinching nut is less likely to become an obstacle.

An eighth preferred embodiment provides the upper support according to any one of the first through seventh preferred embodiments, wherein the at least one upper attachment hole comprises a plurality of upper attachment holes formed at respective circumferential locations in the upper metal member, the at least one lower attachment hole comprises a plurality of lower attachment holes formed at respective circumferential locations in the lower metal member, and the at least one clinching nut comprises a plurality of clinching nuts inserted through the respective lower attachment holes while being fitted into the respective upper attachment holes such that the upper metal member and the lower metal member are fixed to each other by means of the plurality of clinching nuts at the respective circumferential locations.

According to the upper support structured following the present preferred embodiment, the upper metal member and the lower metal member can be stably fixed to each other only by the fixing structure by means of the clinching nuts.

According to the present disclosure, the tightening structure with respect to the vehicle body side comprises the clinching nut. This makes it possible to adopt the upper support even when the space on the upper side of the upper support is narrow.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is a cross sectional view of an upper support according to a first practical embodiment of the present disclosure in a mounted state on a vehicle;

FIG. 2 is a cross sectional view of the upper support shown in FIG. 1, corresponding to a cross section taken along line 2-2 of FIG. 3;

FIG. 3 is a bottom plan view of the upper support shown in FIG. 2;

FIG. 4 is an enlarged front view of a clinching nut constituting the upper support shown in FIG. 2;

FIG. 5 is a top plan view of the clinching nut shown in FIG. 4; and

FIG. 6 is a cross sectional view taken along line 6-6 of FIG. 5.

### DETAILED DESCRIPTION

A practical embodiment of the present disclosure will be described below in reference to the drawings.

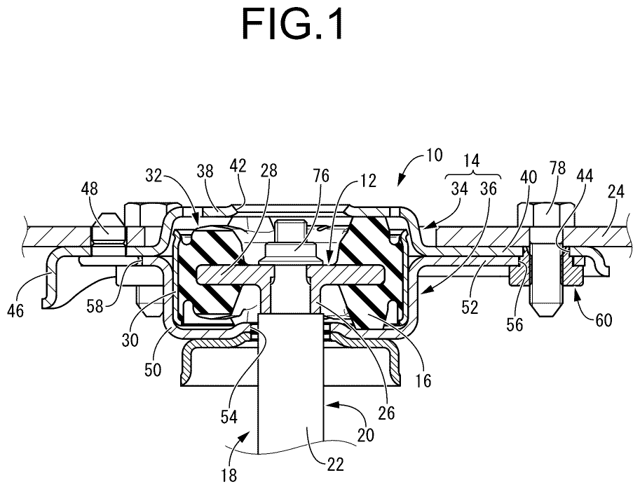

FIG. 1 shows an upper support 10 according to a first practical embodiment of the present disclosure in a mounted state on a vehicle. In the following description, as a general rule, the vertical direction refers to the vertical direction in FIG. 1. Besides, in FIG. 1, illustration of a coil spring, a spring seat rubber, a bound stopper, a dust cover, and the like is omitted.

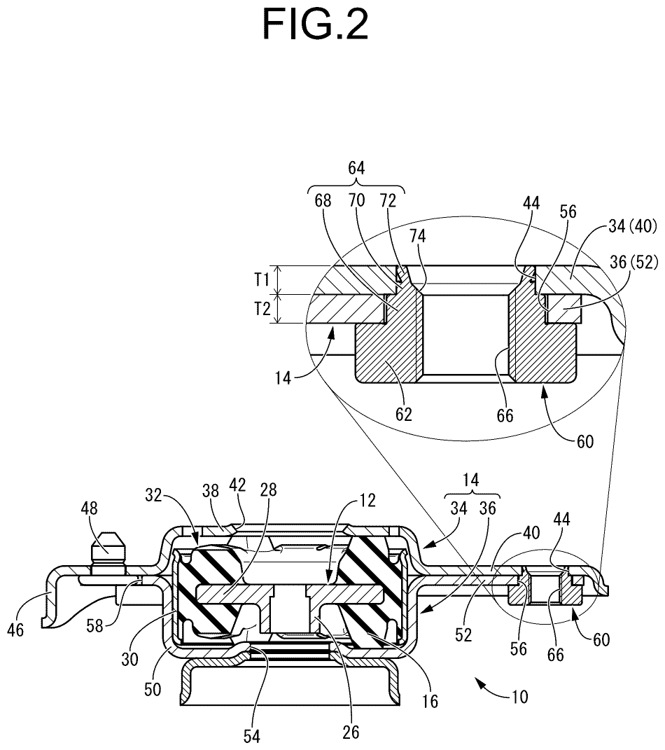

As shown in FIG. 2, the upper support 10 has a structure in which an inner attachment member 12 and an outer attachment member 14 are elastically connected to each other by an elastic connection body 16. The inner attachment member 12 is attached to the upper end of a piston rod 22 of a shock absorber 20 in a suspension 18, while the outer attachment member 14 is attached to a vehicle body 24, so that the suspension 18 and the vehicle body 24 are connected to each other via the upper support 10 in a vibration damping manner.

The inner attachment member 12 is high rigidity component made of metal, hard fiber-reinforced synthetic resin, or the like. Besides, the inner attachment member 12 is integrally provided with an attachment part 26 having an approximately round tubular shape and a fastening part 28 having a flange shape protruding radially outward from the upper end of the attachment part 26. The upper end portion of the inner hole of the attachment part 26 has a shape of opposing flats comprising a pair of mutually opposed planes, so that the inner attachment member 12 and the piston rod 22 are positioned in the circumferential direction by the shape of opposing flats.

The elastic connection body 16 is fastened to the fastening part 28 of the inner attachment member 12. The elastic connection body 16 is made of vulcanized rubber or resin elastomer having rubber-like elasticity. The elastic connection body 16 has an approximately annular shape, and its inner circumferential portion is fastened to the outer circumferential end of the fastening part 28 of the inner attachment member 12, while its outer circumferential portion protrudes to the radially outer side of the fastening part 28. The inner circumferential portion of the elastic connection body 16 protrudes to both the upper and lower sides from the fastening part 28, and the protrusion height from the fastening part 28 varies in the circumferential direction.

An intermediate sleeve 30 is fastened to the outer circumferential surface of the elastic connection body 16. The intermediate sleeve 30 has a thin-walled, large-diameter, approximately round tubular shape, and is preferably made of metal. The inner attachment member 12 is inserted into the intermediate sleeve 30, and the inner attachment member 12 and the intermediate sleeve 30 are elastically connected to each other by the elastic connection body 16 to constitute a vibration damping body 32. The vibration damping body 32 can also be obtained as an integrally vulcanization molded component of the elastic connection body 16 incorporating the inner attachment member 12 and the intermediate sleeve 30.

The outer attachment member 14 is attached to the vibration damping body 32. The outer attachment member 14 comprises an upper metal member 34 and a lower metal member 36 that are overlapped on each other in the vertical direction.

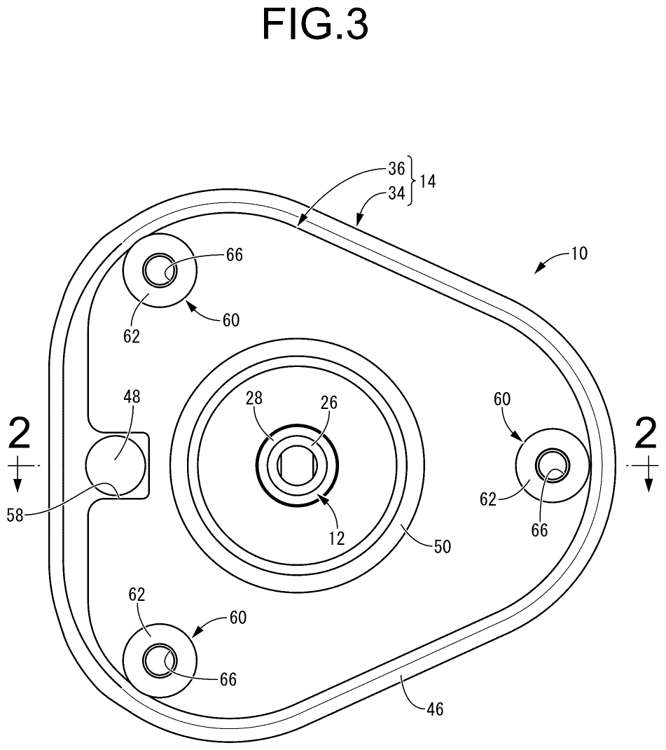

The upper metal member 34 is integrally provided with a lid part 38 of approximately round tubular shape with a bottom opening downward, and an upper flange part 40 projecting radially outward from the lower end of the lid part 38. The upper base wall of the lid part 38 includes an upper through hole 42 penetrating its center portion in the vertical direction. As shown in FIG. 3, the upper flange part 40 has an approximately rounded triangular shape as viewed in the vertical direction, and three rounded corners curved in the circumferential direction include respective upper attachment holes 44 penetrating the rounded corners in the vertical direction. In the present practical embodiment, since each upper attachment hole 44 is formed in the upper flange part 40, the hole length dimension of the upper attachment hole 44 is the same as the thickness dimension T1 of the upper flange part 40. As shown in FIG. 2, the outer peripheral end of the upper flange part 40 includes a reinforcing part 46 that is bent and protrudes downward, thereby affording improvement in deformation rigidity of the upper flange part 40. The upper flange part 40 is penetrated by a positioning pin 48 from below to above.

The lower metal member 36 is integrally provided with a housing part 50 of approximately round tubular shape with a bottom opening upward, and a lower flange part 52 projecting radially outward from the upper end of the housing part 50. The bottom wall of the housing part 50 includes a lower through hole 54 penetrating its center portion in the vertical direction, allowing insertion of the piston rod 22. As shown in FIG. 3, the lower flange part 52 has an approximately rounded triangular shape as viewed in the vertical direction, and three round corners curved in the circumferential direction include respective lower attachment holes 56 penetrating the rounded corners in the vertical direction. In the present practical embodiment, since each lower attachment holes 56 is formed in the lower flange part 52, the hole length dimension of the lower attachment hole 56 is the same as the thickness dimension T2 of the lower flange part 52. The lower flange part 52 is slightly smaller in outside diameter than the upper flange part 40, and is located on the radial inside of the reinforcing part 46 of the upper flange part 40. The lower flange part 52 includes a notch 58 through which the head part of the positioning pin 48 is inserted. The orientation of the upper metal member 34 and the lower metal member 36 in the circumferential direction is defined by contact between the head part of the positioning pin 48 and the inner surface of the notch 58 when the upper metal member 34 and the lower metal member 36 are being fixed together, as described later.

The upper metal member 34 and the lower metal member 36 are pre-painted metal members that have been subjected to painting in advance to prevent corrosion and the like. In the present practical embodiment, the upper metal member 34 and the lower metal member 36 are each cation-coated in the isolated state, and the entire surface is coated with anti-corrosive paint. The method of painting the upper metal member 34 and the lower metal member 36 is not limited in particular.

As shown in FIG. 2, the upper metal member 34 and the lower metal member 36 are fixed to each other by clinching nuts 60, with the upper flange part 40 and the lower flange part 52 overlapped on each other in the vertical direction.

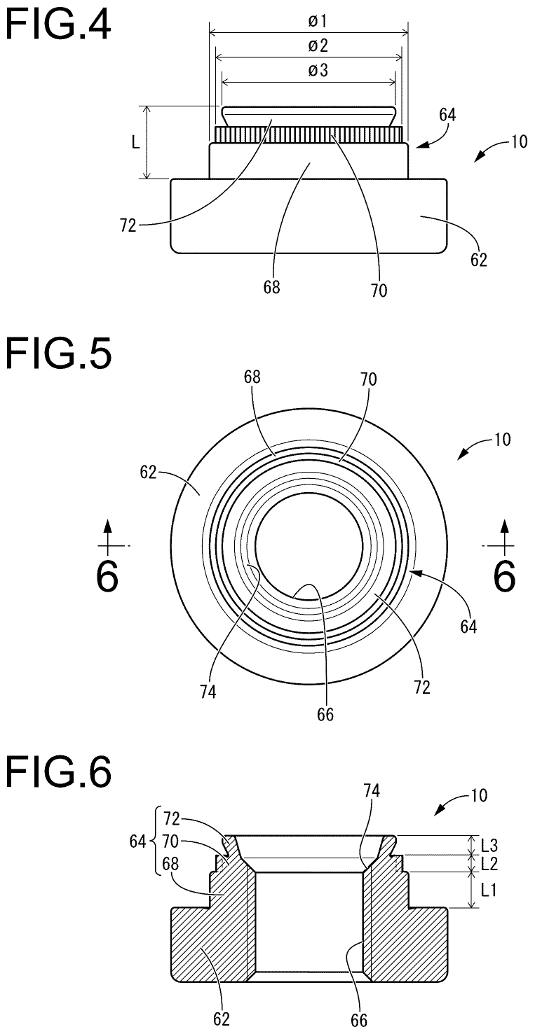

Each clinching nut 60 is made of metal, for example, iron (stainless steel), aluminum alloy, or the like. As shown in FIGS. 4 to 6, the clinching nut 60 is integrally provided with a head part 62 having an approximately round tubular shape, and a small-diameter attachment shaft part 64 protruding upward from the head part 62. The clinching nut 60 includes a screw hole 66 penetrating the center portions of the head part 62 and the attachment shaft part 64 in the vertical direction, and screw threads are formed on the inner circumferential surface of the screw hole 66.

The attachment shaft part 64 has a small-diameter, round tubular shape overall, and can be inserted into the upper and lower attachment holes 44, 56. The length dimension L of the attachment shaft part 64 is not greater than the sum of the hole length dimension of the upper attachment hole 44 and the hole length dimension of the lower attachment hole 56, in other words, the sum of the thickness dimension T1 of the upper flange part 40 and the thickness dimension T2 of the lower flange part 52. The attachment shaft part 64 is integrally provided with an insertion part 68 protruding upward from the head part 62, a fitting part 70 protruding upward from the insertion part 68, and an expansion part 72 protruding upward from the fitting part 70.

The outer circumferential surface of the insertion part 68 is a smooth cylindrical surface. The insertion part 68 has an outside diameter dimension ø1 that is slightly smaller than the hole diameter dimension of the lower attachment hole 56. It is desirable that the outside diameter dimension ø1 of the insertion part 68 be larger than the diameter dimension of the upper attachment hole 44. The length dimension L1 of the insertion part 68 is not greater than the thickness dimension T2 of the lower flange part 52, and in preferred practice, is slightly shorter than the thickness dimension T2 of the lower flange part 52.

The fitting part 70 has a maximum outside diameter dimension ø2 that is larger than the hole diameter dimension of the upper attachment hole 44, and is smaller than the outside diameter dimension ø1 of the insertion part 68. The outer circumferential surface of the fitting part 70 is knurled to prevent rotation in a fitted state in the upper attachment hole 44 as described later. While the shape of the knurled outer circumferential surface of the fitting part 70 is not limited in particular, a multitude of concave grooves extending in the vertical direction are formed. This makes it easy to fit the fitting part 70 into the upper attachment hole 44 while preventing rotation of the clinching nut 60 with respect to the outer attachment member 14. In the present practical embodiment, the entire fitting part 70 comprises a knurled part subjected to the knurling process, but for example, the knurled part may be partially set in the circumferential and/or axial direction. The inner circumferential surface of the fitting part 70 comprises a tapered surface 74 that slopes radially outward toward the top.

The length dimension L2 of the fitting part 70 in the vertical direction is smaller than the length dimension L1 of the insertion part 68. The length dimension L2 of the fitting part 70 is smaller than the hole length dimension of the upper attachment hole 44, in other words, the thickness dimension T1 of the upper flange part 40, and is within a range of 30-80% of the thickness dimension T1 of the upper flange part 40, for example. In the present practical embodiment, the length dimension L2 of the fitting part 70 is about 50% of the thickness dimension T1 of the upper flange part 40.

The expansion part 72 protrudes upward from the fitting part 70 and constitutes the upper end of the clinching nut 60. The expansion part 72 has an expanded shape that slopes radially outward toward the upper side, namely, the protruding distal end side. Both the inner circumferential surface and the outer circumferential surface of the expansion part 72 slope radially outward toward the top. The inner circumferential surface of the expansion part 72 is connected to the tapered surface 74 of the fitting part 70 at the lower end. The maximum outside diameter dimension ø3 of the expansion part 72 is smaller than the maximum outside diameter dimension ø2 of the fitting part 70. The sum of the length dimension L2 of the fitting part 70 and the length dimension L3 of the expansion part 72 is not greater than the thickness dimension T1 of the upper flange part 40. Accordingly, the length dimension L of the attachment shaft part 64 is not greater than the sum of the thickness dimensions T1 of the upper flange part 40 and the thickness dimension T2 of the lower flange part 52.

As shown in FIG. 2, the clinching nut 60 of the above construction is attached to the upper and lower metal members 34, 36 with the head part 62 overlapped on the lower surface of the lower flange part 52 of the lower metal member 36 while the attachment shaft part 64 inserted into the upper attachment hole 44 of the upper metal member 34 and the lower attachment hole 56 of the lower metal member 36. More specifically, the head part 62 of the clinching nut 60 is larger in diameter than the lower attachment hole 56, and the entire upper surface of the head part 62 overlaps the lower surface of the lower flange part 52 in a state of contact. Besides, the attachment shaft part 64 of the clinching nut 60 is inserted from below into the mutually aligned upper and lower attachment holes 44, 56, so that the insertion part 68 is inserted into the lower attachment hole 56 and the fitting part 70 is fitted into the upper attachment hole 44. With this configuration, the upper flange part 40 of the upper metal member 34 and the lower flange part 52 of the lower metal member 36 are fixed to each other by the clinching nut 60 in an overlapped state of approximately close contact, thereby forming the outer attachment member 14.

The upper metal member 34 and the lower metal member 36 are fixed to each other at three circumferential locations by the clinching nuts 60 being attached to the respective upper and lower attachment holes 44, 56 provided at three circumferential locations. The upper metal member 34 and the lower metal member 36 have no fixing structure other than the clinching nuts 60, and are fixed to each other in the overlapped state by means of the clinching nuts 60 alone. In this way, the upper metal member 34 and the lower metal member 36 are fixed to each other by means of the fitting structure of the clinching nuts 60 alone without being fixed by welding. Thus, even if the upper metal member 34 and the lower metal member 36 have been subjected to anti-corrosive painting in advance, the troubles such as the paint being melt due to the heat generated during welding do not occur. Besides, since the upper metal member 34 and the lower metal member 36 are pre-painted metal members that have been painted in advance, the inner surfaces of the lid part 38 and the housing part 50, where the vibration damping body 32 is housed, are also painted. Accordingly, compared to the case where the fittings are painted after assembly, better anti-corrosive performance can be achieved. The embodiment of attachment of the clinching nuts 60 to the upper and lower attachment holes 44, 56 provided at three locations in the circumferential direction is common, and regarding every clinching nut 60, the insertion part 68 is inserted into the lower attachment hole 56, and the fitting part 70 is fitted and fixed to the hole inner surface of the upper attachment hole 44. Additionally, in preferred practice, for example, the positioning pin 48 and a cup metal member overlapped on the lower surface of the housing part 50 of the lower metal member 36 are also pre-painted metal members that have been painted in advance. Other metal members, such as the inner attachment member 12 and the intermediate sleeve 30 of the vibration damping body 32, and the clinching nuts 60, need not be painted, but can also be pre-painted metal members.

Regarding the clinching nut 60, the outside diameter dimension ø1 of the insertion part 68 is smaller than the hole diameter dimension of the lower attachment hole 56. This allows the fitting part 70 of the clinching nut 60 to be fitted more reliably with the hole inner surface of the upper attachment hole 44, and the upper metal member 34 and the lower metal member 36 are more stably connected by the clinching nut 60. Even in the attached state of the clinching nut 60 to the upper and lower metal members 34, 36 shown in FIG. 2, the outside diameter dimension ø1 of the insertion part 68 is larger than the hole diameter dimension of the upper attachment hole 44, thereby preventing the insertion part 68 from entering the upper attachment hole 44.

The length dimension L of the attachment shaft part 64 of the clinching nut 60 is not greater than the sum of the thickness dimensions T1 of the upper flange part 40 and the thickness dimension T2 of the lower flange part 52 (the sum of the hole length dimensions of the upper attachment hole 44 and the lower attachment hole 56), so that the attachment shaft part 64 does not protrude above the upper flange part 40. In particular, the insertion part 68 is larger in diameter than the upper attachment hole 44 to prevent the insertion part 68 from being accidentally inserted into the upper attachment hole 44. Besides, the sum of the length dimensions (L2+L3) of the fitting part 70 and the expansion part 72 that are inserted into the upper attachment hole 44 is not greater than the thickness dimension T1 of the upper flange part 40, so that the expansion part 72 does not protrude above the upper flange part 40.

By adopting the clinching nut 60, the vertical dimension of the upper support 10 at the overlapped portion of the upper flange part 40 and the lower flange part 52 is reduced, thereby affording downsizing of the upper support 10.

The vibration damping body 32 is arranged between the lid part 38 of the upper metal member 34 and the housing part 50 of the lower metal member 36. Regarding the vibration damping body 32, the intermediate sleeve 30 is fixed to the lower metal member 36 by the lower part of the intermediate sleeve 30 being press-fitted into the peripheral wall inner surface of the housing part 50. The inner hole of the inner attachment member 12 is exposed upward through the upper through hole 42 of the lid part 38 while being exposed downward through the lower through hole 54 of the housing part 50. The vibration damping body 32 is set in the housing part 50 in advance before the upper metal member 34 and the lower metal member 36 are fixed by the clinching nut 60. By the upper metal member 34 and the lower metal member 36 being fixed by the clinching nut 60, the vibration damping body 32 is housed between the upper metal member 34 and the lower metal member 36. In the elastic connection body 16 of the vibration damping body 32, regarding the portions protruding from the fastening part 28 of the inner attachment member 12 to both the upper and lower sides, the portion having the larger protruding dimension is pressed against the upper metal member 34 or the lower metal member 36 to be vertically pre-compressed, while the portion having the smaller protruding dimension is vertically opposed and remote from the upper metal member 34 or the lower metal member 36. With this arrangement, when vibration with relatively small amplitude is input in the vertical direction, the pre-compressed portion of the elastic connection body 16 exhibits relatively soft spring characteristics. Meanwhile, when vibration with large amplitude is input in the vertical direction, harder spring characteristics (stopper characteristics) are exhibited due to the remotely opposed portion of the elastic connection body 16 coming into contact with the upper and lower metal members 34, 36.

As shown in FIG. 1, in the upper support 10 constructed in the above manner, the piston rod 22 of the shock absorber 20 in the suspension 18 is inserted through the inner attachment member 12, and a nut 76 is screwed onto the upper end of the piston rod 22 protruding upward from the inner attachment member 12, so that the inner attachment member 12 is fixed to the piston rod 22. Since the upper through hole 42 is formed in the upper base wall of the lid part 38 of the upper metal member 34, the nut 76 can be tightened through the upper through hole 42. Besides, a bolt 78 penetrating the vehicle body 24 overlapped on the upper surface of the upper flange part 40 is screwed into the clinching nut 60 of the outer attachment member 14 from the upper side, whereby the outer attachment member 14 is attached to the vehicle body 24. In this way, the upper support 10 is interposed between the piston rod 22 of the suspension 18 and the vehicle body 24, and connects those piston rod 22 and vehicle body 24 to each other in a vibration damping manner.

Since the bolt 78 is screwed from the upper side into the clinching nut 60, the bolt 78 does not protrude significantly above the vehicle body 24, and the protrusion height of the bolt 78 from the vehicle body 24 to the upper side is minimized. Therefore, even in the case where the space above the vehicle body 24 is narrow due to placement of other components or the like, it is possible to adopt the upper support 10 without interference with other components.

Since the clinching nut 60 does not protrude above the upper flange part 40, the overlap of the vehicle body 24 on the upper surface of the upper flange part 40 is not hampered by the clinching nut 60. In the present practical embodiment, the length dimension L2 of the fitting part 70 is within the range of 30-80% of the thickness dimension T1 of the upper flange part 40. Thus, upward thickness deviation or the like, which is caused by the fitting part 70 being press-fitted into the upper attachment hole 44, is less likely to reach the upper surface of the upper flange part 40, while obtaining sufficient fixing force by means of fitting. Therefore, a stable overlapped state of the vehicle body 24 on the upper surface of the upper flange part 40 is realized.

Since the expansion part 72 is provided at the upper end of the clinching nut 60, when the bolt 78 is inserted into the clinching nut 60, the bolt 78 is readily guided by the inner circumferential surface of the expansion part 72 into the inner hole of the clinching nut 60, thereby achieving improvement in workability. In the present practical embodiment, the inner circumferential surface of the fitting part 70, which is continuously provided below the expansion part 72, comprises the tapered surface 74. This configuration is able to guide the bolt 78 to the appropriate position in the radial direction with respect to the clinching nut 60, thereby facilitating the tightening operation.

A practical embodiment of the present disclosure has been described in detail above, but the present disclosure is not limited to those specific descriptions. For example, the specific structure of the clinching nut is not necessarily limited to the structure of the preceding first practical embodiment. As a specific example, the expansion part 72 can be omitted in the attachment shaft part 64. Also, the knurled part provided in the fitting part 70 of the attachment shaft part 64 in the first practical embodiment is not essential. Besides, for example, the outside diameter dimensions of the insertion part 68 and the fitting part 70 may be approximately the same, or the fitting part 70 may be larger in diameter than the insertion part 68.

The attachment shaft part 64 of the clinching nut 60 may protrude above the upper surface of the upper flange part 40. In this case, for example, it is desirable to have a structure in which the bolt insertion hole of the vehicle body 24, through which the bolt 78 is inserted, is larger in diameter than the upper attachment hole 44, so that the vehicle body 24 does not interfere with the upper end of the attachment shaft part 64. In such a case where the attachment shaft part 64 protrudes above the upper surface of the upper flange part 40, the clinching nut may also adopt a structure in which the upper end of the attachment shaft part 64 is deformed to expand by a jig and is fixed by swaging to the upper flange part 40.

None of the number, arrangement, and size of the locations where the upper metal member 34 and the lower metal member 36 are fixed by the clinching nuts 60 is limited. However, in order to stably keep the upper metal member 34 and the lower metal member 36 in the fixed state, it is desirable to fix them at a plurality of locations.

It is also possible to provide a spare clinching nut 60 that is not screwed with the fixing bolt 78 upon installation in a vehicle. For example, in a different vehicle, the said spare clinching nut 60 may be screwed with the fixing bolt 78, or the like. By selectively using such an excess clinching nut 60 in this way, the upper and lower metal members 34, 36 can be shared among multiple types of vehicles, and the like.

What is claimed is:

1. An upper support comprising:
an inner attachment member configured to be attached to a piston rod of a shock absorber in a suspension of a vehicle;
an outer attachment member configured to be attached to a vehicle body; and
an elastic connection body connecting the inner attachment member and the outer attachment member, wherein
the outer attachment member comprises an upper metal member and a lower metal member overlapped on each other, and the inner attachment member and the elastic connection body are arranged between the upper metal member and the lower metal member,
the upper metal member includes at least one upper attachment hole penetrating the upper metal member in a vertical direction, and the lower metal member includes at least one lower attachment hole penetrating the lower metal member in the vertical direction, and
at least one clinching nut comprising a head part overlapped on a lower surface of the lower metal member is inserted through the lower attachment hole from below and is fitted and fixed to the upper attachment hole such that the upper metal member and the lower metal member are fixed to each other in an overlapped state by means of the clinching nut alone.

2. The upper support according to claim 1, wherein both the upper metal member and the lower metal member comprise pre-painted metal members that have been painted in advance.

3. The upper support according to claim 1, wherein
the clinching nut further comprises an insertion part inserted into the lower attachment hole and a fitting part fitted into the upper attachment hole, and
an outer circumferential surface of the insertion part comprises a cylindrical surface, and an outer circumferential surface of the fitting part comprises a knurling part.

4. The upper support according to claim 3, wherein an upper end of the clinching nut comprises an expansion part protruding upward from the fitting part and expanding toward a protruding distal end side.

5. The upper support according to claim 3, wherein the fitting part has a maximum outside diameter dimension that is smaller than that of the insertion part.

6. The upper support according to claim 3, wherein the fitting part has a vertical length dimension that is within a range of 30%-80% of a hole length dimension of the upper attachment hole.

7. The upper support according to claim 1, wherein
the clinching nut includes an attachment shaft part protruding from the head part and inserted through the lower attachment hole while being fitted into the upper attachment hole, and
the attachment shaft part has a length dimension that is not greater than a sum of hole length dimensions of the upper attachment hole and the lower attachment hole.

8. The upper support according to claim 1, wherein
the at least one upper attachment hole comprises a plurality of upper attachment holes formed at respective circumferential locations in the upper metal member,
the at least one lower attachment hole comprises a plurality of lower attachment holes formed at respective circumferential locations in the lower metal member, and
the at least one clinching nut comprises a plurality of clinching nuts inserted through the respective lower attachment holes while being fitted into the respective upper attachment holes such that the upper metal member and the lower metal member are fixed to each other by means of the plurality of clinching nuts at the respective circumferential locations.
